(19) United States
(12) Patent Application Publication
(10) Pub. No.: US 2019/0303605 A1
(43) Pub. Date: Oct. 3, 2019

(54) INFORMATION PROCESSING APPARATUS, CONTROL METHOD, AND PROGRAM

(71) Applicant: NEC CORPORATION, Tokyo (JP)

(72) Inventor: Junya OKABE, Tokyo (JP)

(73) Assignee: NEC CORPORATION, Tokyo (JP)

(21) Appl. No.: 16/367,812

(22) Filed: Mar. 28, 2019

(30) Foreign Application Priority Data
Mar. 29, 2018 (JP) 2018-065520

(51) Int. Cl. G06F 21/62; G06F 17/22

(52) U.S. Cl. CPC G06F 21/6218; G06F 21/6209; G06F 17/2264; G06F 17/2217

(57) ABSTRACT

An information processing apparatus extracts one or more strings to be determined from a path name string, and determines necessity of masking for each of the strings to be determined. The necessity of masking is determined based on the appearance number of the string to be determined in a string group extracted from the path name strings of a plurality of files handled by a target system.

### BACKGROUND

### Technical Field

The invention relates to masking of a path name of a file.

### Related Art

Analysis such as security analysis or system failure analysis may be performed on the path name of each file existing on the computer system. With respect to directory names and file names which are elements of path names, since names representing the feature of the data therein are often assigned, the names may include sensitive information such as personal information or confidential information. For example, the name of a directory in which data related to a certain project is collectively stored may include the name of the project, the name of the company involved in the project, and the like. In many cases, it is not preferable that such information is disclosed even to an analyst who analyzes the system. Hereinafter, information that is not to be disclosed to a third party, including the analyst of the system, is called “sensitive information”.

As a method for preventing sensitive information included in a path name from being disclosed to an analyst, there is a method of replacing at least a part of a string constituting the path name with another character (for example, a symbol such as an asterisk) and concealing it. Hereinafter, replacing a character constituting a path name with another character in this way is called “masking”.

As documents in the related art disclosing a technique relating to masking of data, there is Japanese Patent Application Publication No. 2009-199385. Japanese Patent Application Publication No. 2009-199385 discloses a technique of defining in advance a keyword or string pattern representing personal information, and masking a portion of input data that matches the keyword or the string pattern.

### SUMMARY

Since names of directories and files are often determined by user's own criteria, there are many pieces of sensitive information among path names that do not match specific keywords or patterns. Therefore, if sensitive information included in a path name is determined by a keyword or a pattern, there is a possibility that sensitive information not matching the keyword or the pattern is disclosed without being masked.

The present invention has been made in view of the above problems. An object of the present invention is to provide a technique for accurately detecting a portion representing sensitive information in a path name of a file.

In one embodiment, there is provided an information processing apparatus comprising memory storing instructions and at least one processor. The at least one processor is configured to execute the instructions to: acquire a path name string representing a path name; extract a target string from the acquired path name string; and determine necessity of masking for the target string, based on an appearance number of the target string in a set of strings extracted from the path name strings of a plurality of files.

In another embodiment, there is provided a control method executed by a computer, comprising: acquiring a path name string representing a path name; extracting a target string from the acquired path name string; and determining the necessity of masking for the target string, based on an appearance number of the target string in a set of strings extracted from the path name strings of a plurality of files.

In still another embodiment, there is provided a non-transitory computer-readable storage medium storing a program causing a computer to execute each step of the control method of the present invention.

According to the present invention, a technique for accurately detecting a portion representing sensitive information in a path name of a file is provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows an overview of the operation of an information processing apparatus of Example Embodiment 1.

FIG. 2 shows the configuration of the information processing apparatus of Example Embodiment 1.

FIG. 3 shows a computer for realizing the information processing apparatus.

FIG. 4 shows a flow of a process performed by the information processing apparatus of Example embodiment 1.

FIG. 5 shows a mask threshold.

FIG. 6 shows a graph representing the appearance numbers of strings.

FIG. 7 is a block diagram illustrating an information processing apparatus including an output unit.

FIG. 8 shows the functional configuration of an information processing apparatus of Example Embodiment 2.

FIG. 9 shows a predefined list in a table format.

FIG. 10 shows a flow of a process performed by the information processing apparatus of Example embodiment 2.

FIG. 11 shows a graph representing the appearance numbers for each string.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Example Embodiments of the present invention will be described below with reference to the drawings. In all the drawings, the same constituent elements are denoted by the same reference numerals, and the description thereof will not appropriately be repeated. Unless otherwise specified, in each block diagram, each block represents a functional unit configuration, instead of a hardware unit configuration.

### Example Embodiment 1

### Overview

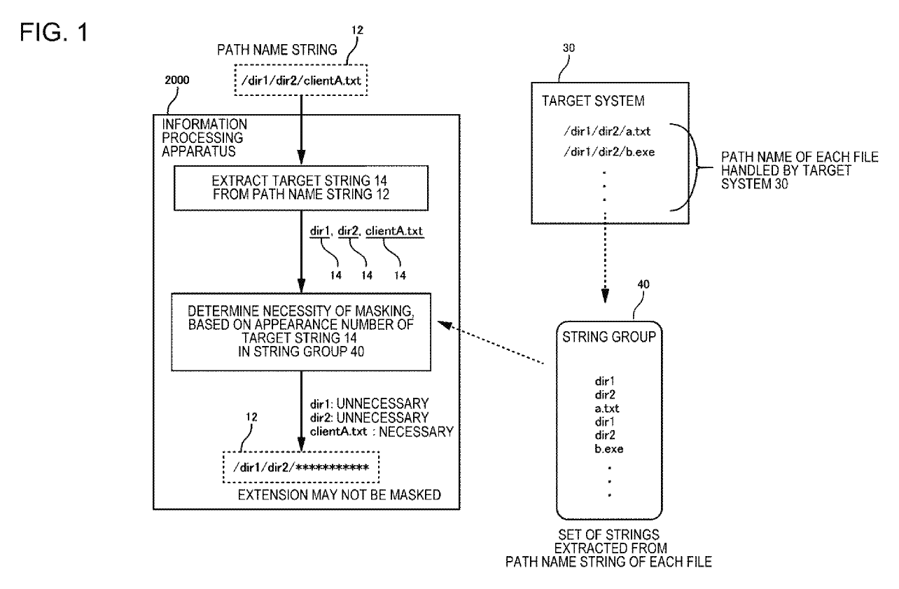

FIG. 1 is a diagram illustrating an overview of the operation of an information processing apparatus of Example Embodiment 1. FIG. 1 is a conceptual diagram for facilitating understanding of the operation of an information processing apparatus 2000, and does not specifically limit the operation of the information processing apparatus 2000.

The information processing apparatus 2000 acquires a path name string 12 and determines the necessity of masking for one or more strings included in the path name string 12. Here, the masking of the string means changing the string to another string.

The path name string 12 is a string representing the path name of the file handled by the system to be analyzed (target system 30). The path name string 12 is used for analysis of the target system 30. The target system 30 is a computer system configured with one or more machines. A single machine may be dedicated to one user or shared by a plurality of users.

For example, the analysis performed on the target system 30 is an analysis on cyber attacks. For example, there is an analysis that performs malware detection and behavior analysis by analyzing the log of process activity in the target system 30, and analyzing how and what file is accessed in each process. At that time, the path name of the accessed file is analyzed. However, the analysis performed in the target system 30 is not limited to security concerns. For example, analysis for finding the cause of system failure can be performed.

The information processing apparatus 2000 masks the portion representing the sensitive information in the path name string 12. To do so, the information processing apparatus 2000 extracts one or more target strings 14 from the path name string 12, and determines the necessity of masking for each target string 14. The target string 14 is, for example, a string representing the name of each of directories and files constituting the path represented by the path name string 12. For example, the target strings 14 extracted from the path name string 12 of “/dir1/dir2/clientA.txt” are “dir1”, “dir2”, and “clientA.txt”.

The information processing apparatus 2000 determines the necessity of masking for each target string 14, based on the appearance number of the target string 14 in a set of strings (hereinafter referred to as a string group 40) extracted from the path name strings of a plurality of files handled by the target system 30.

Here, it can be considered that there is a high probability that the names of directories and files prepared in advance in association with the operating system (OS) and applications do not represent sensitive information, compared with directories and files independently created by the user. Examples of such directories and files include executable files and configuration files of the OS and applications, directories for storing them, and the like. Since the names of directories and files prepared in advance in association with the OS and the application appear in common among a plurality of machines and users that use the same OS and application, the appearance number in the target system 30 is large.

On the other hand, it can be considered that there is a high probability that the names of directories and files independently created by the user represent sensitive information. Since the names of directories and files independently created by the user are not common among a plurality of machines and users that use the same OS and applications in many cases, the appearance number in the target system 30 is small.

In this way, it is considered that there is a correlation between the probability that the names of directories and files represent sensitive information and the appearance number of the name in the target system 30 (that is, the appearance number in the string group 40).

Therefore, the information processing apparatus 2000 determines that masking is necessary for the target string 14 having a relatively small appearance number in the string group 40, and determines that masking is unnecessary for the target string 14 having a relatively large appearance number in the string group 40. As described above, by determining the necessity of masking with reference to the appearance number in the string group 40, even in a situation where it is difficult to previously determine a string representing sensitive information or its pattern, sensitive information included in the path name string 12 can be appropriately detected.

Note that, as a simple method of reliably masking sensitive information, it is conceivable to mask all the characters constituting the path name. By doing so, the sensitive information is not disclosed to the third person at all. However, with this method, it becomes impossible to obtain useful information by analyzing the path name.

In this regard, according to the information processing apparatus 2000, the target string 14 having a relatively large appearance number in the string group 40 is not masked. By doing this, sensitive information can be concealed while leaving the parts useful for analysis in the path name string 12 as they are as much as possible. That is, according to the information processing apparatus 2000, it is possible to realize both the analysis of the system using the path name string 12 and the concealment of sensitive information.

Hereinafter, the information processing apparatus 2000 of the present example embodiment will be described in more detail.

### Example of Functional Configuration of Information Processing Apparatus 2000

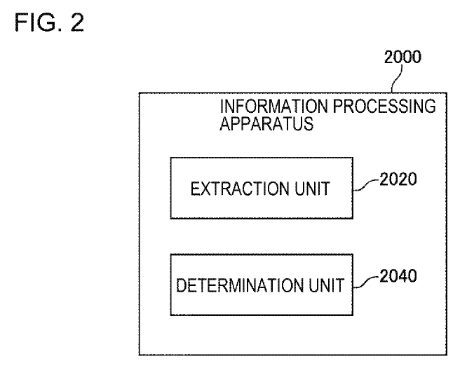

FIG. 2 is a diagram illustrating the configuration of the information processing apparatus 2000 of Example Embodiment 1. The information processing apparatus 2000 includes an extraction unit 2020 and a determination unit 2040. The extraction unit 2020 extracts a target string 14 from the path name string 12. The determination unit 2040 determines the necessity of masking for the target string 14, based on the appearance number of the target string 14 in the string group 40.

### Hardware Configuration of Information Processing Apparatus 2000

Each functional configuration unit of the information processing apparatus 2000 may be realized by hardware (for example, a hard-wired electronic circuit) that realizes each functional configuration unit, or a combination of hardware and software (for example, a combination of an electronic circuit, a program for controlling the electronic circuit, and the like). Hereinafter, the case where each functional configuration unit of the information processing apparatus 2000 is realized by a combination of hardware and software will be further described.

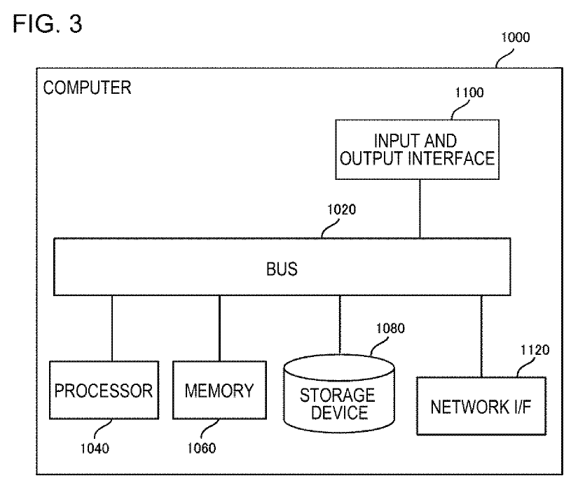

FIG. 3 is a diagram illustrating the computer 1000 for realizing the information processing apparatus 2000. The computer 1000 is any computer. For example, the computer 1000 is a personal computer (PC), a server machine, a tablet terminal, a smartphone, or the like. The computer 1000 may be a special-purpose computer designed to realize the information processing apparatus 2000 or may be a general-purpose computer.

The computer 1000 includes a bus 1020, a processor 1040, a memory 1060, a storage device 1080, an input and output interface 1100, and a network interface 1120. The bus 1020 is a data transmission path through which the processor 1040, the memory 1060, the storage device 1080, the input and output interface 1100, and the network interface 1120 mutually transmit and receive data. However, a method of connecting the processor 1040 and the like to each other is not limited to bus connection. The processor 1040 is a processor such as a central processing unit (CPU), a graphics processing unit (GPU), a field-programmable gate array (FPGA), or the like. The memory 1060 is a primary storage realized by using a random access memory (RAM) or the like. The storage device 1080 is a secondary storage realized by using a hard disk drive, a solid state drive (SSD), a memory card, a read only memory (ROM), or the like. However, the storage device 1080 may be configured with the same hardware as the hardware constituting the main storage device, such as a RAM.

The input and output interface 1100 is an interface for connecting the computer 1000 and an input and output device. The network interface 1120 is an interface for connecting the computer 1000 to a communication network. The communication network is, for example, a local area network (LAN) or a wide area network (WAN). The method by which the network interface 1120 connects to the communication network may be a wireless connection or a wired connection.

The storage device 1080 stores program modules that realize the functional configuration units of the information processing apparatus 2000. The processor 1040 reads these respective program modules into the memory 1060 and executes them, thereby realizing the respective functions corresponding to the respective program modules.

### Process Flow

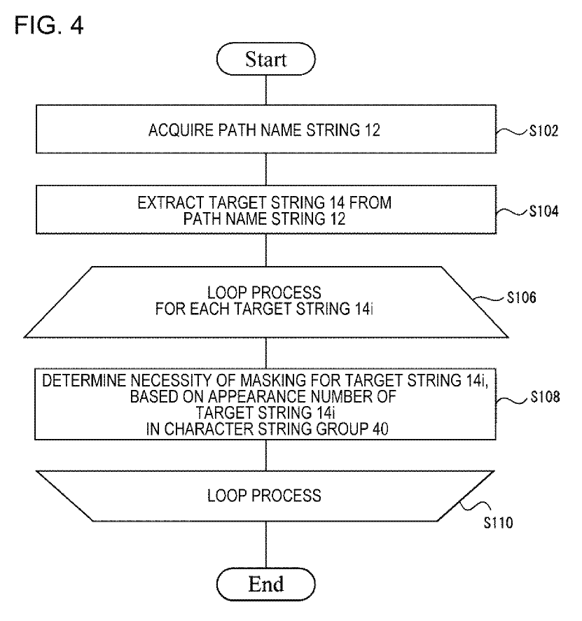

FIG. 4 is a flowchart illustrating the flow of a process executed by the information processing apparatus 2000 of Example Embodiment 1. The extraction unit 2020 acquires a path name string 12 (S102). The extraction unit 2020 extracts a target string 14 from the path name string 12 (S104).

S106 to S110 are a loop process executed on each of the target strings 14 extracted from the path name string 12. In S106, the extraction unit 2020 determines whether or not there is a target string 14 that has not been subjected to the loop process. In a case where there is the target string 14 that has not been subjected to the loop process, the extraction unit 2020 selects one of them. The target string 14 selected here is referred to as a target string 14i. Thereafter, the process of FIG. 4 proceeds to S108. On the other hand, in a case where the loop process has already been performed for all the target strings 14, the process in FIG. 4 ends.

In S108, the determination unit 2040 determines whether or not a mask of the target string 14i is necessary, based on the appearance number of the target string 14i in the string group 40. Since S110 is the end of the loop process, the process of FIG. 4 returns to S106.

### Acquisition of Path Name String 12: S102

The extraction unit 2020 acquires a path name string 12 (S102). As described above, the path name string 12 is a string representing the path name of the file handled by the target system 30. Note that, the path name string 12 may be a relative path or an absolute path.

The extraction unit 2020 acquires the path name string 12 in various ways. For example, the extraction unit 2020 determines the path name of each file handled by the target system 30, and acquires a string representing each determined path name as the path name string 12. In this case, for example, the extraction unit 2020 determines the path name of each file handled by the target system 30, by accessing the file system managing the file handled by the target system 30.

In another example, the extraction unit 2020 extracts the path name of the accessed file from the log by analyzing the file access log (for example, the process operation log) in the target system 30, and handles that path name as the path name string 12. Here, the path name recorded in the log may be a relative path when handling an absolute path as the path name string 12. In this case, the extraction unit 2020 handles the absolute path obtained by converting the relative path extracted from the log as the path name string 12. Note that, existing methods can be used for converting relative paths into absolute paths.

In another example, information indicating the path name string 12 may be stored in advance in the storage device. In this case, the extraction unit 2020 acquires the path name string 12 by reading this information from the storage device. In a case where a plurality of path name strings 12 are indicated in the above information, the information processing apparatus 2000 processes each of the path name strings 12 included in this information.

### Extraction of String 14 to be Determined: S104

The extraction unit 2020 extracts a target string 14 from the path name string 12. Specifically, the extraction unit 2020 extracts a string representing a directory name or a file name from the path name string 12, and handles each of the extracted strings as the target string 14. Note that, exiting techniques can be used for a technique for extracting a directory name and a file name from a path name.

Note that, the target string 14 representing the file name may be the entire file name including the extension, or may be the file name excluding the extension from the entire file name. Further, in the case where the target string 14 is the file name excluding the extension from the entire file name, when masking the target string 14, the entire file name including the extension can be masked, or the extension may not be masked.

### Determination of Necessity of Mask: S108

The determination unit 2040 determines the necessity of masking for the target string 14 (S108). As described above, the determination unit 2040 determines the necessity of masking for the target string 14, based on the appearance number of the target string 14 in the string group 40. For example, the determination unit 2040 determines whether or not the appearance number of the target string 14 is equal to or larger than a threshold (hereinafter referred to as a mask threshold) determined based on the appearance number of each string in the string group 40. When the appearance number of the target string 14 is equal to or larger than the mask threshold, the determination unit 2040 determines that a mask is unnecessary. When the appearance number of the target string 14 is less than the mask threshold, the determination unit 2040 determines that a mask is necessary.

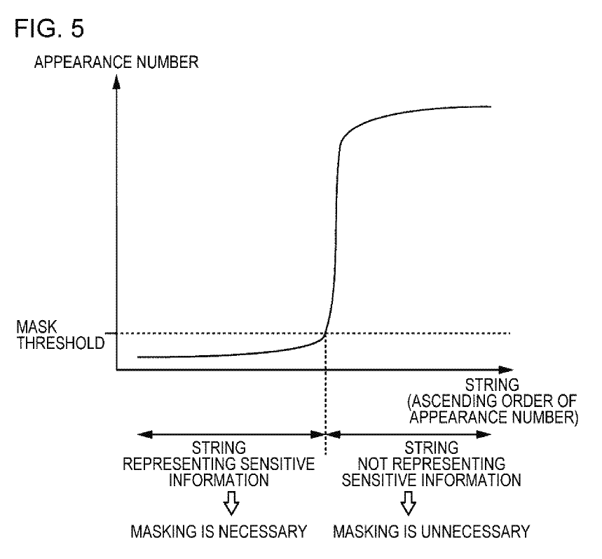

FIG. 5 is a diagram illustrating a mask threshold. The graph of FIG. 5 represents strings sorted in ascending order of appearance number on the horizontal axis and the appearance number of the corresponding string on the vertical axis (concrete strings and appearance numbers is not described). As shown in this graph, there is a high probability that there is a large divergence between the appearance numbers of strings that do not represent sensitive information and the appearance numbers of strings that represent sensitive information. Thus, for example, in the distribution of strings included in the string group 40, the mask threshold can be determined based on the portion in which there is a large divergence in the appearance number.

Here, the mask threshold may be determined in advance at an arbitrary timing or may be determined when the determination unit 2040 makes a determination on the first one of target strings 14. In the former case, the mask threshold may be determined by an apparatus other than the information processing apparatus 2000. In the following description, it is assumed that the mask threshold is determined by the determination unit 2040 in order to make the explanation easier to understand.

There are various methods for specifically determining the mask threshold. For example, the determination unit 2040 divides each string included in the string group 40 into two clusters, with reference to the magnitude of appearance number in the string group 40. Here, a cluster in which a string having a larger appearance number is stored is called a first cluster, and a cluster in which a string having a smaller appearance number is stored is called a second cluster. The determination unit 2040 determines a mask threshold, based on a minimum appearance number in the first cluster and a maximum appearance number in the second cluster. For example, the determination unit 2040 sets either one of the minimum appearance number in the first cluster and the maximum appearance number in the second cluster as the mask threshold. In another example, the determination unit 2040 sets the average value of the minimum appearance number in the first cluster and the maximum appearance number in the second cluster, as the mask threshold.

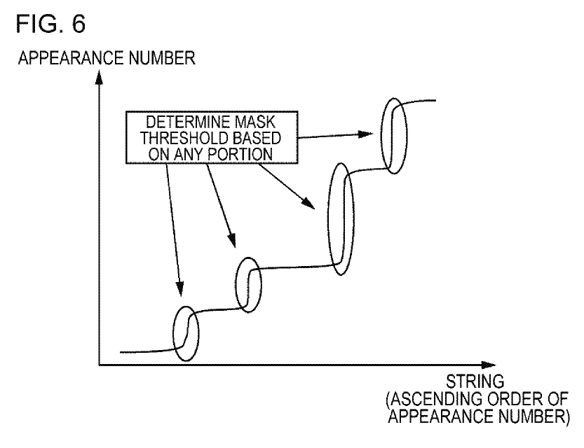

Here, the strings included in the string group 40 are not necessarily divided into two portions of a portion with a larger appearance number and a portion with a smaller appearance number, as shown in FIG. 5. FIG. 6 is a diagram illustrating a graph representing the appearance numbers of strings. In the graph of FIG. 6, unlike the graph of FIG. 5, there is a plurality of portions where the appearance number of the string increases greatly.

Therefore, the determination unit 2040 may cluster strings included in the string group 40 with strings having similar appearance numbers, without determining the number of clusters in advance. In this case, for example, the determination unit 2040 selects any two adjacent clusters in the order of appearance number, handles the two selected clusters in the same way as the first cluster and the second cluster described above, and determines the mask threshold.

Here, there are various methods for selecting the two clusters. For example, the determination unit 2040 randomly selects two adjacent clusters. In another example, the determination unit 2040 may select the cluster with the largest appearance number and the cluster with the next largest appearance number. In another example, the determination unit 2040 may select two adjacent clusters based on the magnitude of the divergence of the appearance number. Specifically, for each of the pairs of adjacent clusters, the determination unit 2040 computes the difference between the maximum value of the appearance number in the cluster located earlier in ascending order of appearance number and the minimum value of the appearance number in the cluster located later. The difference describes the magnitude of an increase in the portion where the appearance number sharply increases in FIG. 6. The determination unit 2040 handles the pair of clusters having the largest difference in the same manner as the above-described first cluster and second cluster, and determines the mask threshold.

### Regarding String Group 40

The string group 40 is a set of strings extracted from the path name strings of a plurality of files handled by the target system 30. In a case of handling the whole of the path name string 12 as the target string 14, each string included in the string group 40 is the whole of the path name string of each file handled by the target system 30. That is, the string group 40 is a set of path name strings of respective files handled by the target system 30. On the other hand, when handling each directory name and file name extracted from the path name string 12 as the target string 14, each string included in the string group 40 is a directory name and a file name extracted from the path name string of each file handled by the target system 30. That is, the string group 40 is a set of the directory names and the file names extracted from the path name string of each file handled by the target system 30.

### Regarding Appearance Number of String

A method of counting the appearance number of the strings in the string group 40 will be described. The appearance number of the string in the string group 40 may be a number obtained by simply counting the number of times appearing in the path name string or may be a number obtained by counting without duplication under a certain rule. In the latter case, for example, the appearance number of a string is not to be counted in duplicate, for the same machine or the same user. That is, the appearance number of a string is counted as the number of machines appearing or the number of users appearing. By doing so, the appearance number of the string in the string group 40 is an index representing how many machines or users commonly use the string. Hereinafter, both the case of counting as the number of machines and the case of counting as the number of users will be described.

### Case for Counting as Number of Machines

For the same machine, the appearance number of the same string is not to be counted in duplicate. In other words, when counting the appearance number for each string obtained from the path name string of the file stored in one machine, its appearance number is 1 (appearing) or 0 (not appearing). By doing this, the appearance number of the string means the number of machines using the string as the path name of the file.

For example, it is assumed that there are files “/dir1/dir2/dir3/a.txt” and “/dir1/dir2/dir4/b.txt” for the same machine. The former path name string is divided into four strings “dir1”, “dir2”, “dir3”, and “a.txt”, and the latter path name string is divided into four strings “dir1”, “dir2”, “dir4”, and “b.txt”. Here, when simply counting the appearance number of a string, the number of dir1 and dir2 is 2, and the number of dir3, dir4, a.txt, and b.txt is 1. However, since the appearance number of the string is counted as the number of machines appearing, the appearance number of dir1 and dir2 is also 1.

### Case for Counting as Number of Users

For the same user, the appearance number of the same string is not to be counted in duplicate. In other words, when counting the appearance number for each string obtained from the path name string of the file owned by a single user (under the user directory of the user), its appearance number is 1 (appearing) or 0 (not appearing). By doing this, the appearance number of the string means the number of users using the string as the path name of the file.

For example, it is assumed that the same machine is used by a plurality of users. It is assumed that there are files “/dir1/user1/dir2/a.txt”, “dir1/user1/dir2/b.txt”, and “/dir1/user2/dir2/c.txt”. The user directory of the user 1 is user1, and each file under user1 is a file owned by the user 1. Similarly, the user directory of the user 2 is user2, and each file under user2 is a file owned by the user 2.

When strings obtained from the above three path name strings are simply counted, the number of dir1 and dir2 is 3, the number of user1 is 2, the number of user2, a.txt, b.txt, and c.txt is 1. On the other hand, under the rule that the same string is not repeatedly counted for the same user, the count number of dir1 and dir2 is 2, and the count number of user1 is 1. Regarding user2, a.txt, b.txt, and c.txt, they stay as 1.

### Weighting of Appearance Number

When counting the appearance number of each string in the string group 40, the appearance number of the string may be counted with a weight. For example, in the case of counting the appearance number of the string as the number of machines, the string is counted with a weight corresponding to the machine using the path name of the file. For example, the appearance number of a string is counted according to the following Expression (1).

[Expression 1]

c[i]=Σⱼw[j]*flag[j], 0≤w[j]≤1 (1)

In Expression (1), i is an identifier assigned to a string. c[i] is the appearance number of the string i. j is the identifier of the machine. flag[j] is: 1 if machine j is using the string i for the path name of the file; and 0 if not used. w[j] indicates how many the machine j increases the appearance number when the machine j uses the string i in the path name of the file. That is, in the method of counting the appearance number of the string i according to Expression (1), in a case where the machine j uses the string i as the path name of the file, the appearance number of the string i is not increased by 1 but by w[j]. By doing so, the appearance number of the string i is counted in consideration of the weight determined for each machine.

Here, the weight of each machine is determined in various ways. For example, a fixed weight is predetermined for each machine. In another example, the weight of the machine may be automatically determined based on the feature of the machine.

There are various ways of determining weights based on machine features. For example, the weight of the machine operating as a server machine is set to be higher, and the weight of the machine operating as a client machine is set to be lower. This is because, in analysis of the target system 30, the server machine is likely to have large importance as the analysis target. Whether a machine is a server machine or a client machine can be estimated, for example, based on the type of OS running on the machine and the type of application. Instead, information indicating whether each machine is a server machine or a client machine may be stored in advance in the storage device.

In another example, a machine with a larger amount of network communication may have a larger weight. This is because, in analysis of the target system 30, machines with more communication traffic on the network are likely to have large importance as the analysis target. Existing techniques can be used for the technique for recognizing the communication traffic of each machine on the network.

In another example, the weight of the machine may be determined according to the network to which the machine belongs. For example, the weight of the machine is determined for each LAN to which the machine belongs. By doing this, for example, it is possible to increase the weight of a machine belonging to a network important for analyzing the target system 30. Here, since there are cases where networks are different for respective departments in a company, in such an environment, it is possible to change the weight for each department by changing the weight for each network. Note that, the network to which the machine belongs can be determined by, for example, the IP address of the machine.

The weight of the machine may be determined by combining a plurality of weights based on the features of various machines described above. For example, the weight of a machine is determined by multiplying a plurality of weights determined based on each feature of the machine.

Here, even in the case of counting the number of users as the appearance number of the string, the appearance number of the string may be counted with the weight corresponding to the user who uses the string as the path name of the file. Even in this case, Expression (1) described above can be used. However, j is the identifier assigned to the user, not the machine. w[j] is the weight assigned to a user j. Further, flag[j] is set to: 1 if the user j uses the string i as the path name of a file; and 0 if the user j does not use it.

Here, the weight of each user is determined in various ways. For example, a fixed weight is predetermined for each user. In another example, the weight of the user may be automatically determined based on the feature of the user. For example, the weight of a user is determined by whether the user is an administrator or a general user, which group the user belongs to, and the like.

### Execution of Masking

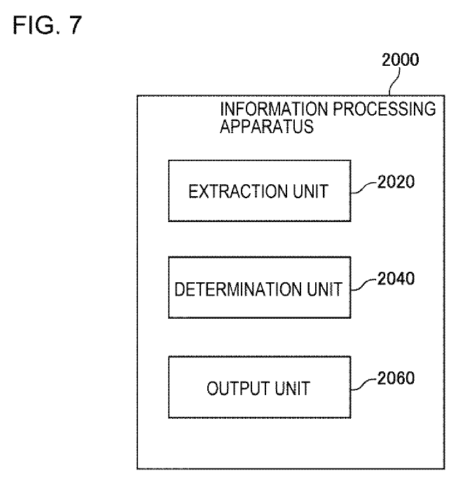

The information processing apparatus 2000 may mask the target string 14, which is determined to require a mask, with respect to the path name string 12, and output the masked path name string 12. The configuration unit having this function is referred to as an output unit 2060. FIG. 7 is a block diagram illustrating the information processing apparatus 2000 including the output unit 2060.

Here, as a method of masking strings, various existing methods can be used. For example, there is a masking method in which each character constituting a string is replaced with a symbol such as an asterisk. Note that, the length of the string before masking and the length of string after masking may be the same as each other or may be different from each other.

The output destination of the path name string 12 is various. For example, the output unit 2060 writes the path name string 12 into a predetermined storage device. The path name string 12 stored in the storage device is used for analysis of the target system 30. In another example, the determination unit 2040 may display the path name string 12 on a display device, or may transmit it another device.

### Example Embodiment 2

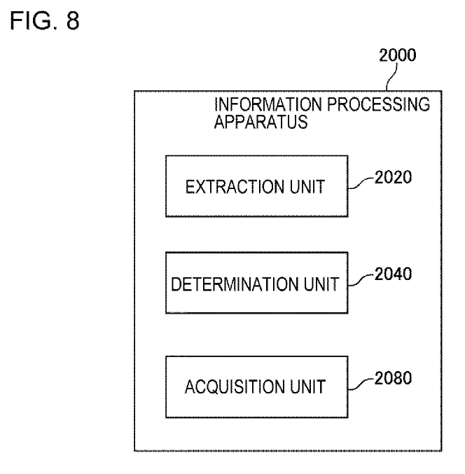

FIG. 8 is a diagram illustrating the functional configuration of the information processing apparatus 2000 of Example Embodiment 2. Except for the features described below, the information processing apparatus 2000 of Example Embodiment 2 has the same functions of the information processing apparatus 2000 of Example Embodiment 1.

The information processing apparatus 2000 of Example Embodiment 2 includes an acquisition unit 2080. The acquisition unit 2080 acquires a predefined list. The predefined list indicates one or both of a string requiring masking and a string not requiring masking. Hereinafter, the predefined list showing only the strings requiring masking is called a black list, and the predefined list showing only the strings not requiring masking is called a white list. The predefined list acquired by the acquisition unit 2080 includes one or both of the black list and the white list.

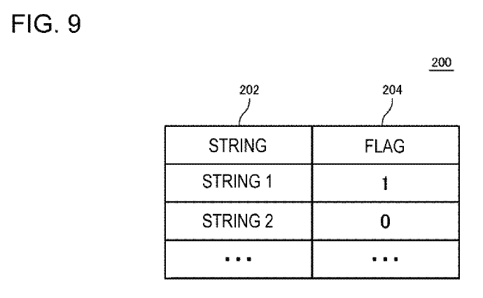

FIG. 9 is a diagram illustrating a predefined list in a table format. The table in FIG. 9 is referred to as a table 200. The table 200 has two columns which are a string 202 and a flag 204. The flag 204 indicates the necessity of masking for the string indicated in the string 202. In FIG. 9, “1” means that masking is necessary, and “0” means that masking is unnecessary.

First, the determination unit 2040 of Example Embodiment 2 determines whether or not the target string 14 is included in the predefined list. In a case where the target string 14 is not included in a predefined list, the determination unit 2040 determines the necessity of masking for the target string 14, based on the appearance number of the target string 14 in the string group 40 (see Example Embodiment 1). On the other hand, in a case where the target string 14 is included in the predefined list, the determination unit 2040 determines the necessity of masking for the target string 14, based on the predefined list.

More specifically, in a case where the predefined list defines the target string 14 as a string requiring masking (in the case where the target string 14 is shown in the black list), the determination unit 2040 determines that the target string 14 is necessary to be masked. On the other hand, in a case where the predefined list defines the target string 14 as a string not requiring masking (in the case where the target string 14 is shown in the white list), the determination unit 2040 determines that the target string 14 is not necessary to be masked.

### Advantageous Effect

It is difficult to define in advance the necessity of masking for all strings. On the other hand, as to the necessity of masking is known beforehand, it can be said that it is preferable to determine the necessity of masking, according to the known information.

According to the information processing apparatus 2000 of the present example embodiment, if the target string 14 is a string defined in the predefined list, the necessity of masking is determined according to the predefined list. By doing this, while it is possible to make it sure to mask strings that are known in advance to require masking, it is possible to make it sure not to mask strings that are known in advance not to require masking. Further, with respect to the target string 14 which is not defined in the predefined list, the necessity of masking is determined according to the appearance number of the target string 14 in the string group 40, by the method described in Example Embodiment 1. By doing this, it is possible to determine the necessity of masking with high accuracy, with respect to a string which cannot be determined in advance for the necessity of masking.

### Example of Hardware Configuration

A hardware configuration of a computer that implements the information processing apparatus 2000 of Example Embodiment 2 is illustrated in FIG. 3, for example, as in Example Embodiment 1. However, in the storage device 1080 of the computer 1000 that implements the information processing apparatus 2000 of the present example embodiment, a program module that implements the functions of the information processing apparatus 2000 according to the present example embodiment is further stored.

### Process Flow

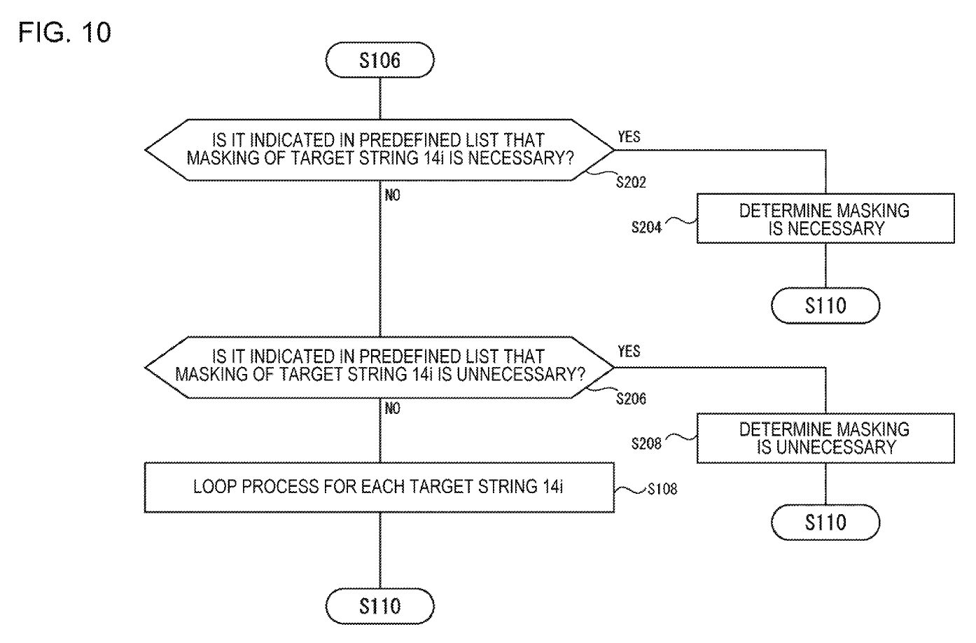

FIG. 10 is a flowchart illustrating a part of the flow of a process executed by the information processing apparatus 2000 of Example Embodiment 2. In FIG. 10, only the content (S106 to S110) of the loop process in FIG. 4 is shown. After S106, the determination unit 2040 determines whether or not it is indicated in the predefined list that the target string 14i requires masking (S202). When it is indicated in the predefined list that the target string 14i requires masking (S202: YES), the determination unit 2040 determines that the target string 14i is necessary to be masked (S204). On the other hand, when it is not indicated in the predefined list that the target string 14i requires masking (S202: NO), the process of FIG. 10 proceeds to S206.

The determination unit 2040 determines whether or not it is indicated that the target string 14i does not require masking (S206). When it is indicated in the predefined list that the target string 14i does not require masking (S206: YES), the determination unit 2040 determines that the target string 14i is not necessary to be masked (S208). On the other hand, when it is not indicated in the predefined list that the target string 14i does not require masking (S204: NO), the process of FIG. 10 proceeds to S108. As a result, by the method described in Example Embodiment 1, the necessity of masking is determined for the target string 14i.

### Other Uses of Predefined List

The predefined list may be used to determine the mask threshold. As described above, as a method of determining the mask threshold, a method of clustering strings included in the string group 40 with strings having similar appearance numbers, without determining the number of clusters in advance is adopted. In this case, two adjacent clusters in the order of appearance number are selected from a plurality of clusters, and a mask threshold is determined based on the selected cluster.

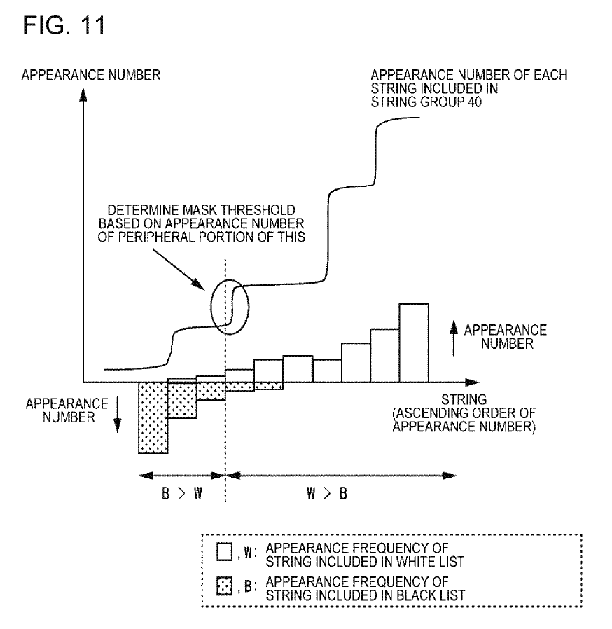

FIG. 11 is a diagram illustrating a graph representing the appearance numbers for each string. In FIG. 11, there are four portions where the appearance number of the string greatly increases. Therefore, when clustering a string based on the appearance number of the string, four clusters are formed. Then, one of the boundaries of these four clusters is used as a mask threshold.

Here, since the strings shown in the white list are strings not representing sensitive information, the appearance number in the target system 30 is expected to be large. Therefore, the strings shown in the white list are distributed to the right side in the graph of FIG. 11. In FIG. 11, a bar graph represented by a while rectangle is a histogram representing the appearance frequency of a string shown in the white list.

On the other hand, since the strings shown in the black list are strings representing sensitive information, the appearance number in the target system 30 is expected to be small. Therefore, the strings shown in the black list are distributed to the left side in the graph of FIG. 11. In FIG. 11, a bar graph represented by a dot pattern rectangle is a histogram representing the appearance frequency of a string shown in the black list.

As described above, the histogram representing the appearance frequencies of the strings shown in the white list is biased to the side of the strings having a larger appearance number, while the histogram representing the appearance frequencies of the strings shown in the black list is biased to the side of the strings having a smaller appearance number. There is high probability that the portion where the magnitude relationship of the two histograms is reversed represents the boundary between strings having high probability of representing sensitive information and strings having low probability of representing sensitive information.

Thus, the determination unit 2040 may determine the mask threshold, based on the magnitude relationship between the two histograms. For example, the determination unit 2040 computes, for each cluster, both the number of strings shown in the white list (hereinafter, referred to as a white number) and the number of strings shown in the black list (hereinafter, referred to as a black number). In this way, in a case where clusters are arranged in ascending order of the appearance number of the string, it becomes “the number of black>the number of white” in the clusters on the front side (the left side in FIG. 11), and it becomes “the number of white>the number of black” in the clusters on the back side (the right side in FIG. 11). Therefore, out of a set of adjacent two clusters, the determination unit 2040 selects the two clusters one of which has “the number of black>the number of white” and the other having “the number of white>the number of black”, and uses the boundary therebetween as a mask threshold.

Although the example embodiments of the present invention have been described with reference to the drawings, these are examples of the present invention, and it is possible to adopt a combination of the above respective example embodiments, or various other configurations.

All or some of the above example embodiments may be listed also in the following notes, but not limited thereto.

1. An information processing apparatus comprising:

memory storing instructions; and

at least one processor configured to execute the instructions to:

acquire a path name string representing a path name;

extract a target string from the acquired path name string; and

determine necessity of masking for the target string, based on an appearance number of the target string in a set of strings extracted from the path name strings of a plurality of files.

2. The information processing apparatus according to 1., wherein the target string is a part or all of a name of either a directory or a file that constitutes the acquired path name string.
3. The information processing apparatus according to 1. or 2., the at least one processor is configured to determine that the target string is necessary to be masked when the appearance number of the target string in the set is equal to or less than a predetermined threshold.
4. The information processing apparatus according to 3., wherein the at least one processor is further configured to:

compute a boundary value between an appearance number of a string representing sensitive information and an appearance number of a string not representing sensitive information, based on the appearance number of each string in the set; and

sets the boundary value as the predetermined threshold.

5. The information processing apparatus according to 4., wherein the at least one processor is further configured to:

divide the strings in the set into a first cluster including the strings having a smaller appearance number and a second cluster including the strings having a larger appearance number; and

compute the boundary value based on a maximum value of the appearance number of the strings included in the first cluster and a minimum value of the appearance number of the strings included in the second cluster.

6. The information processing apparatus according to any one of 1. to 5., wherein the at least one processor is further configured to:

acquire a predefined list which is information indicating at least one of a string that requires masking and a string that does not require masking;

determine that the target string is necessary to be masked when the target string is indicated as requiring masking in the predefined list;

determine that the target string is not necessary to be masked when the target string is indicated as not requiring masking in the predefined list; and

determine necessity of masking for the target string which is not shown in the predefined list, based on the appearance number of the target string.

7. The information processing apparatus according to 6., wherein the at least one processor is further configured to:

compute a boundary value between the appearance number of the string representing sensitive information and the appearance number of the string not representing sensitive information, on the basis of: the appearance number of each string in the set; a distribution of an appearance number of the string which is in the set and is indicated as requiring masking in the predefined list; and a distribution of an appearance number of the string which is in the set and is indicated as not requiring masking in the predefined list; and

determine that the target string is necessary to be masked, when the appearance number of the target string in the set is equal to or less than the boundary value.

8. The information processing apparatus according to any one of 1. to 7., wherein the at least one processor is further configured to count the appearance number of each string in the set according to a weight attached to a machine or a user handling a file including the string in the path name string.
9. The information processing apparatus according to any one of 1. to 8., where in the at least one processor is further configured to output the path name string in which the target string determined to be masked is masked.
10. A control method executed by a computer, comprising:

acquiring a path name string representing a path name;

extracting a target string from the acquired path name string; and

determining the necessity of masking for the target string, based on an appearance number of the target string in a set of strings extracted from the path name strings of a plurality of files.

11. The control method according to 10., wherein the target string is a part or all of a name of either a directory or a file that constitutes the acquired path name string.
12. The control method according to 10. or 11., further comprising determining that the target string is necessary to be masked when the appearance number of the target string in the set is equal to or less than a predetermined threshold.
13. The control method according to 12., further comprising:

computing a boundary value between an appearance number of a string representing sensitive information and an appearance number of a string not representing sensitive information, based on the appearance number of each string in the set; and

setting the boundary value as the predetermined threshold.

14. The control method according to 13., further comprising:

dividing the strings in the set into a first cluster including the strings having a smaller appearance number and a second cluster including the strings having a larger appearance number; and

computing the boundary value based on a maximum value of the appearance number of the strings included in the first cluster and a minimum value of the appearance number of the strings included in the second cluster.

15. The control method according to any one of 10. to 14., wherein further comprising:

acquiring a predefined list which is information indicating at least one of a string that requires masking and a string that does not require masking;

determining that the target string is necessary to be masked when the target string is indicated as requiring masking in the predefined list;

determining that the target string is not necessary to be masked when the target string is indicated as not requiring masking in the predefined list; and

determining necessity of masking for the target string which is not shown in the predefined list, based on the appearance number of the target string.

16. The control method according to 15., further comprising:

computing a boundary value between the appearance number of the string representing sensitive information and the appearance number of the string not representing sensitive information, on the basis of: the appearance number of each string in the set; a distribution of an appearance number of the string which is in the set and is indicated as requiring masking in the predefined list; and a distribution of an appearance number of the string which is in the set and is indicated as not requiring masking in the predefined list; and

determining that the target string is necessary to be masked, when the appearance number of the target string in the set is equal to or less than the boundary value.

17. The control method according to any one of 10. to 16., further comprising counting the appearance number of each string in the set according to a weight attached to a machine or a user handling a file including the string in the path name string.
18. The control method according to any one of 10. to 17., further comprising outputting the path name string in which the target string determined to be masked is masked.
19. A non-transitory computer-readable storage medium storing a program that causes a computer to:

acquire a path name string representing a path name;

extract a target string from the acquired path name string; and

determine the necessity of masking for the target string, based on an appearance number of the target string in a set of strings extracted from the path name strings of a plurality of files.

20. The non-transitory computer-readable storage medium according to 19., wherein the target string is a part or all of a name of either a directory or a file that constitutes the acquired path name string.
21. The non-transitory computer-readable storage medium according to 19. or 20., wherein the program further causes the computer to determine that the target string is necessary to be masked when the appearance number of the target string in the set is equal to or less than a predetermined threshold.
22. The non-transitory computer-readable storage medium according to 21., wherein the program further causes the computer to:

compute a boundary value between an appearance number of a string representing sensitive information and an appearance number of a string not representing sensitive information, based on the appearance number of each string in the set; and

set the boundary value as the predetermined threshold.

23. The non-transitory computer-readable storage medium according to 22., wherein the program further causes the computer to:

divide the strings in the set into a first cluster including the strings having a smaller appearance number and a second cluster including the strings having a larger appearance number; and

compute the boundary value based on a maximum value of the appearance number of the strings included in the first cluster and a minimum value of the appearance number of the strings included in the second cluster.

24. The non-transitory computer-readable storage medium according to any one of 19. to 23., wherein the program further causes the computer to:

acquire a predefined list which is information indicating at least one of a string that requires masking and a string that does not require masking;

determine that the target string is necessary to be masked when the target string is indicated as requiring masking in the predefined list;

determine that the target string is not necessary to be masked when the target string is indicated as not requiring masking in the predefined list; and

determine necessity of masking for the target string which is not shown in the predefined list, based on the appearance number of the target string.

25. The non-transitory computer-readable storage medium according to 24., wherein the program further causes the computer to:

compute a boundary value between the appearance number of the string representing sensitive information and the appearance number of the string not representing sensitive information, on the basis of: the appearance number of each string in the set; a distribution of an appearance number of the string which is in the set and is indicated as requiring masking in the predefined list; and a distribution of an appearance number of the string which is in the set and is indicated as not requiring masking in the predefined list; and

determine that the target string is necessary to be masked, when the appearance number of the target string in the set is equal to or less than the boundary value.

26. The non-transitory computer-readable storage medium according to any one of 19. to 25., wherein the program further causes the computer to count the appearance number of each string in the set according to a weight attached to a machine or a user handling a file including the string in the path name string.
27. The non-transitory computer-readable storage medium according to any one of 19. to 26., where in the program further causes the computer to output the path name string in which the target string determined to be masked is masked.

It is apparent that the present invention is not limited to the above embodiment, and may be modified and changed without departing from the scope and spirit of the invention.

This application claims the benefit of priority from Japanese Patent Application No. 2018-065520 filed on Mar. 29, 2018, the entire disclosure of which is incorporated herein.

What is claimed is:

1. An information processing apparatus comprising:
memory storing instructions; and
at least one processor configured to execute the instructions to:
acquire a path name string representing a path name;
extract a target string from the acquired path name string; and
determine necessity of masking for the target string, based on an appearance number of the target string in a set of strings extracted from the path name strings of a plurality of files.

2. The information processing apparatus according to claim 1, wherein the target string is a part or all of a name of either a directory or a file that constitutes the acquired path name string.

3. The information processing apparatus according to claim 1, the at least one processor is configured to determine that the target string is necessary to be masked when the appearance number of the target string in the set is equal to or less than a predetermined threshold.

4. The information processing apparatus according to claim 3, wherein the at least one processor is further configured to:
compute a boundary value between an appearance number of a string representing sensitive information and an appearance number of a string not representing sensitive information, based on the appearance number of each string in the set; and
sets the boundary value as the predetermined threshold.

5. The information processing apparatus according to claim 4, wherein the at least one processor is further configured to:
divide the strings in the set into a first cluster including the strings having a smaller appearance number and a second cluster including the strings having a larger appearance number; and
compute the boundary value based on a maximum value of the appearance number of the strings included in the first cluster and a minimum value of the appearance number of the strings included in the second cluster.

6. The information processing apparatus according to claim 1, wherein the at least one processor is further configured to:
acquire a predefined list which is information indicating at least one of a string that requires masking and a string that does not require masking;
determine that the target string is necessary to be masked when the target string is indicated as requiring masking in the predefined list;
determine that the target string is not necessary to be masked when the target string is indicated as not requiring masking in the predefined list; and
determine necessity of masking for the target string which is not shown in the predefined list, based on the appearance number of the target string.

7. The information processing apparatus according to claim 6, wherein the at least one processor is further configured to:
compute a boundary value between the appearance number of the string representing sensitive information and the appearance number of the string not representing sensitive information, on the basis of: the appearance number of each string in the set; a distribution of an appearance number of the string which is in the set and is indicated as requiring masking in the predefined list; and a distribution of an appearance number of the string which is in the set and is indicated as not requiring masking in the predefined list; and
determine that the target string is necessary to be masked, when the appearance number of the target string in the set is equal to or less than the boundary value.

8. The information processing apparatus according to claim 1, wherein the at least one processor is further configured to count the appearance number of each string in the set according to a weight attached to a machine or a user handling a file including the string in the path name string.

9. The information processing apparatus according to claim 1, where in the at least one processor is further configured to output the path name string in which the target string determined to be masked is masked.

10. A control method executed by a computer, comprising:
acquiring a path name string representing a path name;
extracting a target string from the acquired path name string; and
determining the necessity of masking for the target string, based on an appearance number of the target string in a set of strings extracted from the path name strings of a plurality of files.

11. A non-transitory computer-readable storage medium storing a program causing a computer to execute:
acquiring a path name string representing a path name;
extracting a target string from the acquired path name string; and
determining the necessity of masking for the target string, based on an appearance number of the target string in a set of strings extracted from the path name strings of a plurality of files.
